(19) United States
(12) Patent Application Publication
(10) Pub. No.: US 2019/0188654 A1
(43) Pub. Date: Jun. 20, 2019

(54) RESOURCE POOLING AND SHARING USING DISTRIBUTED LEDGER SYSTEMS

(71) Applicant: SAP SE, Walldorf (DE)

(72) Inventor: Frank Albrecht, Walldorf (DE)

(21) Appl. No.: 15/844,986

(22) Filed: Dec. 18, 2017

(51) Int. Cl. G06Q 20/06; G06Q 10/06

(52) U.S. Cl. CPC G06Q 20/065; G06Q 10/06313

(57) ABSTRACT

Implementations of the present disclosure include methods, systems, and computer-readable storage mediums for receiving, from a first computing device, a request for a transaction to be executed during a cooperative effort, the request requesting resources, each resource being associated with an amount of digital currency, receiving, from a second computing device, a response to the request, the response indicating that a second entity at least partially fulfills the request, recording the request and the response in a DLS, each of the first computing device and the second computing device communicating with the DLS, logging the request and the response in respective resource planning systems of the first entity and the second entity, the resource planning systems communicating with respective nodes of the DLS, and, upon ending of the cooperative effort, facilitating reconciliation between the first entity and the second entity based on transaction data recorded in the DLS.

### BACKGROUND

Multiple entities can work together in a cooperative effort to achieve some end. For example, nations can work together to perform disaster relief activities. In such instances, entities pool and share resources. Example resources can include equipment, fuel, food, and the like. Each entity records its interactions, and a settlement between entities can occur. However, records between entities may be inconsistent, and/or inaccurate resulting in a time-consuming, resource inefficient, and error prone reconciliation.

### SUMMARY

Implementations of the present disclosure include computer-implemented methods for tracking pooled, and shared resources between entities. More particularly, implementations of the present disclosure are directed to leveraging a distributed ledger system (DLS) to track pooled, and shared resources between multiple entities, and providing reconciliation between the multiple entities.

In some implementations, actions include receiving, from a first computing device associated with a first entity participating in a cooperative effort, a request for a transaction to be executed during the cooperative effort, the request requesting one or more resources, each resource being associated with an amount of digital currency, receiving, from a second computing device associated with a second entity participating in the cooperative effort, a response to the request, the response indicating that the second entity at least partially fulfills the request, recording the request and the response in a distributed ledger system (DLS), each of the first computing device and the second computing device communicating with respective nodes of the DLS, logging one or more of the request and the response in respective resource planning systems of the first entity and the second entity, the resource planning systems communicating with respective nodes of the DLS, and, upon ending of the cooperative effort, facilitating reconciliation between the first entity and the second entity based on transaction data recorded in the DLS. Other implementations include corresponding systems, apparatus, and computer programs, configured to perform the actions of the methods, encoded on computer storage devices.

These and other implementations may each optionally include one or more of the following features: each of the first computing device and the second computing device execute an application that facilitates communication with the DLS; each resource planning system communicates with the DLS through a respective cloud platform instance; the transaction data is recorded in a blockchain of the DLS; reconciliation at least partially includes exchanging a balance of digital currency of one of the first entity and the second entity to a local currency; the amount of digital currency is defined in a contract on the DLS; and the digital currency is specific to the cooperative effort.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example environment that can be used to execute implementations of the present disclosure.

FIG. 2 depicts an example conceptual architecture in accordance with implementations of the present disclosure.

FIGS. 3A-3I depict example screenshots in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure include computer-implemented methods for tracking pooled, and shared resources between entities. More particularly, implementations of the present disclosure are directed to leveraging a distributed ledger system (DLS) to track pooled, and shared resources between multiple entities, and providing reconciliation between the multiple entities.

To provide further context for implementations of the present disclosure, and as introduced above, multiple entities can work together during a cooperative effort to achieve some end. During the co-working, entities can pool, and share resources. For example, one entity can provide equipment, and another entity can provide fuel. In some examples, when a resource is provided form one entity to another entity, some value can be assigned to the transaction for subsequent settlement. In traditional systems, each entity records the details of the transaction, and the respective recordings are reconciled during the subsequent settlement. However, records between entities may be inconsistent, and/or inaccurate resulting in a time-consuming, resource inefficient, and error prone reconciliation.

In view of this, implementations of the present disclosure provide a resource sharing platform for recording resource sharing transactions between entities, and enabling settlement based on the recorded transactions. More particularly, the resource sharing platform of the present disclosure leverages a DLS to immutably record transactions between entities, and support reconciliation and settlement. In some implementations, the resource sharing platform implements a digital currency that can be used to assign value to transactions. In some examples, the digital currency is specific to a cooperative effort that the multiple entities are participating in (e.g., an effort, in which multiple entities perform tasks to achieve one or more goals).

Implementations of the present disclosure are described in further detail herein with reference to an example context. The example context includes multiple entities provided as countries that work together (e.g., pooling, sharing resources) to conduct a cooperative effort, such as, disaster recovery. It is contemplated, however, that implementations of the present disclosure can be realized with any appropriate context.

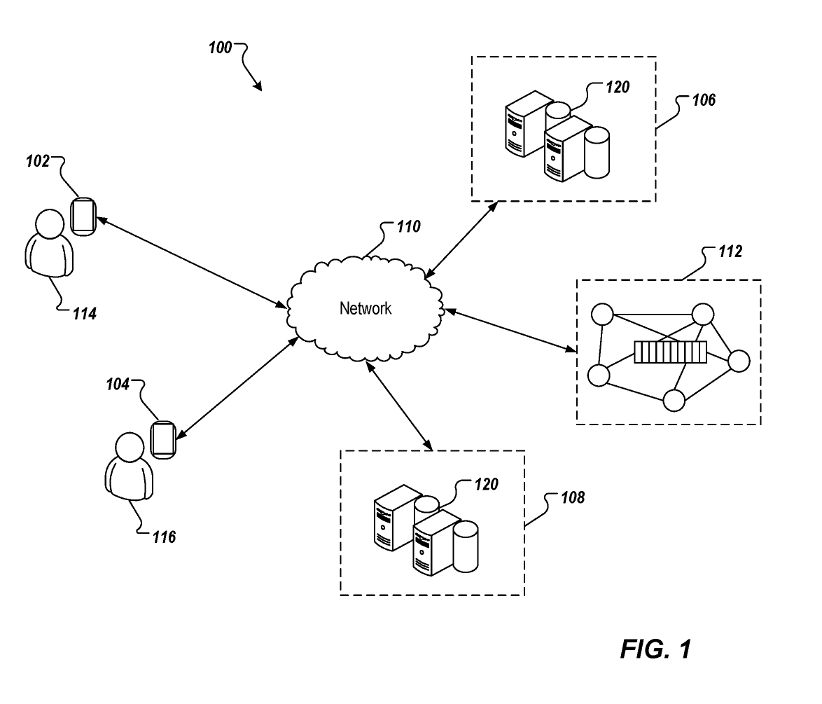

FIG. 1 depicts an example environment 100 that can be used to execute implementations of the present disclosure. In some examples, the example environment 100 enables users associated with respective entities (e.g., soldiers assisting in disaster relief efforts) to request, and record transactions between entities using computing devices in a computer-implemented resource sharing platform. The example environment 100 includes computing devices 102, 104, back-end systems 106, 108, a network 110, and a DLS 112. In some examples, the computing devices 102, 104 are used by respective users 114, 116 to log into and interact with the resource sharing platform of the present disclosure.

In the depicted example, the computing devices 102, 104 are provided as mobile computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106, 108). In some examples, the network 110 can be accessed over a wired and/or a wireless communications link. For example, mobile computing devices, such as smartphones can utilize a cellular network to access the network 110.

In the depicted example, the back-end systems 106, 108 each include at least one server system 120. In some examples, the at least one server system 120 hosts one or more computer-implemented services that users can interact with using computing devices. For example, the back-end system 106 can host computer-implemented services of a first entity (e.g., country), such as an enterprise resource planning (ERP) system that the first entity uses to manage its resources. The back-end system 108 can host computer-implemented services of a second entity (e.g., country), such as an ERP system that the second entity uses to manage its resources. In some examples, the user 114 is an agent of the first entity, and interacts with the ERP system hosted on the back-end system 106 using the computing device 102. In some examples, the user 116 is an agent of the second entity, and interacts with the ERP system hosted on the back-end system 108 using the computing device 104. An example ERP system can be provided in, without limitation, SAP Business Suite 4 SAP HANA (SAP S/4HANA) provided by SAP SE of Walldorf, Germany, which is a business suite that is built on SAP HANA, an operational database system, and in-memory computing platform also provided by SAP SE.

In some examples, the computing devices 102, 104 each includes a computer-executable application executed thereon, which can be used to log into the respective ERP systems, and/or the resource sharing platform of the present disclosure. In some examples, the computing devices 102, 104 each include a web browser application executed thereon, which can be used to display one or more web pages of the respective ERP services, and/or the resource planning platform of the present disclosure.

In accordance with implementations of the present disclosure, a resource sharing platform leverages the DLS 112 to immutably record transactions between entities during a cooperative effort. Example transaction can include, without limitation, one entity purchasing resources from another entity, one entity borrowing resources from another entity. In some implementations, each transaction is recorded in the DLS 112. In some examples, a transaction is validated using a cryptographic blockchain infrastructure (blockchain) of the distributed ledger system. In some examples, each of the computing devices 102, 104 communicate nodes of the DLS 112 to effect transactions, described in further detail herein. The ERP systems of the respective entities participating in the cooperative effort also communicate with nodes of the DLS 112 to record the transactions.

In some implementations, the blockchain is an existing blockchain that is accessed by various networks. An example blockchain includes, but is not limited to the Bitcoin blockchain. In some implementations, the blockchain is an application-specific blockchain (e.g., a blockchain that is dedicated to recording transactions of cooperative efforts). For example, the application-specific blockchain is a blockchain that is specifically provided for cooperative efforts (e.g., as opposed to a blockchain that is provided for numerous, different applications).

To provide further context for the present disclosure, a high-level discussion of blockchain technology is provided. In general, a blockchain is a ledger of all transactions that have ever been executed in one or more contexts (e.g., multi-entity transactions in cooperative efforts). A blockchain constantly grows as completed blocks are added with a new set of transactions. In some examples, a single block is provided from multiple transactions (e.g., multiple transfers of resources). In general, blocks are added to the blockchain in a linear, chronological order by one or more computing devices in a peer-to-peer network of interconnected computing devices that execute a blockchain protocol. In short, the peer-to-peer network can be described as a plurality of interconnected nodes, each node being a computing device that uses a client to validate and relay transactions (e.g., resource transfers). Each node maintains a copy of the blockchain, which is automatically downloaded to the node upon joining the peer-to-peer network. A blockchain protocol provides a secure and reliable method of updating the blockchain, copies of which are distributed across the peer-to-peer network, without the need for a central authority.

Because all users (e.g., entities) need to know all previous transactions (e.g., resource transfers) to validate a requested transaction (e.g., payment for resources), all users must agree on which transactions have actually occurred, and in which order. That is, all users must come to a consensus. For example, if two users observe different transaction histories, they will be unable to come to the same conclusion regarding the validity of a transaction. In some examples, all users agree on the same rules used to validate transactions (e.g., as provided in the blockchain protocol), thus coming to a consensus. In some examples, a blockchain enables all users to come to an agreement as to transactions that have already occurred, and in which order. In short, and as described in further detail below, a ledger of transactions is agreed to based on the amount of work required to add a transaction to the ledger of transactions (e.g., add a block to the blockchain). In this context, the work is a task that is difficult (e.g., mathematically, computationally) for any single node (e.g., computing device) in the peer-to-peer network to quickly complete, but is relatively easy for a node (e.g., computing device) to verify.

The peer-to-peer network includes so-called miners (e.g., computing devices) that add blocks to a blockchain based on the blockchain protocol. In general, multiple miners validate transactions that are to be added to a block, and compete (e.g., perform work, as introduced above) to have their block added to the blockchain. Validation of transactions includes verifying digital signatures associated with respective transactions. For a block to be added to the blockchain, a miner must demonstrate a proof of work before their proposed block of transactions is accepted by the peer-to-peer network, and is added to the blockchain.

A blockchain protocol includes a proof of work scheme that is based on a cryptographic hash function (CHF). An example CHF includes the secure hash algorithm 256 (SHA-256). In general, the CHF receives information as input, and provides a hash value as output, the hash value being of a predetermined length. For example, SHA-256 outputs a 256-bit (32-byte, 64-character) hash value. In some examples, the hash value is a one-way hash value, in that the hash value cannot be ‘un-hashed’ to determine what the input was. The blockchain protocol can require multiple pieces of information as input to the CHF. For example, the input to the CHF can include a reference to the previous (most recent) block in the blockchain, details of the transaction(s) that are to be included in the to be created block, and a nonce value (a random number used only once).

As introduced above, multiple nodes compete to hash a set of transactions and provide the next block that is to be added to the blockchain. The blockchain protocol provides a threshold hash to qualify a block to be added to the blockchain. For example, the threshold hash can include a predefined number of zeros (0's) that the hash value must have at the beginning (e.g., at least the first four characters of the hash value must each be zero). The higher the number of zeros, the more time-consuming it is to arrive at a qualifying hash value.

In accordance with the blockchain protocol, each miner in the peer-to-peer network receives transaction information for one or more transactions that are to be included in a block that is to be added next in the blockchain. Each miner provides the reference to the previous (most recent) block in the blockchain, details of the transaction(s) that are to be included in the to be created block, and the nonce value to the CHF to provide a hash value. If the hash value does not meet the threshold hash (e.g., the first four characters of the hash value are not each zero), the miner starts again to provide another hash value. If the hash value meets the threshold hash (e.g., at least the first four characters of the hash value are each zero), the respective miner successfully created the next block that is to be added to the blockchain. Consequently, the respective miner's block is broadcast across the peer-to-peer network. All other miners cease work (because one miner was already successful, and all other miners accept that block as valid), and all copies of the blockchain are updated across the peer-to-peer network to append the block to the blockchain. Each miner may be required to produce hundreds or thousands (or even millions, billions, or trillions) of hash values, before any one miner provides a qualifying hash value.

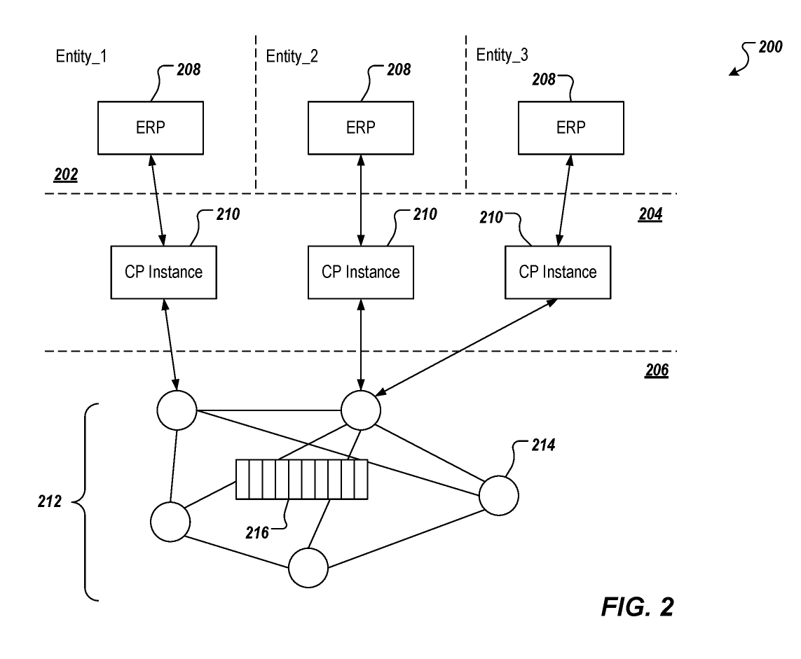

FIG. 2 depicts an example conceptual architecture 200 in accordance with implementations of the present disclosure. The example architecture 200 includes an entity layer 202, a hosted services layer 204, and a DLS layer 206. In the depicted example, the entity layer 202 includes three entities, Entity_1 (E1), Entity_2 (E2), and Entity_3 (E3), each entity having a respective resource management system 208 (e.g., ERP system, such as SAP S/4HANA introduced above). In some examples, one or more of the resource management systems 208 can be provided as an on-premise system (e.g., hosted in a server system of the respective entity). In some examples, one or more of the resource management systems 208 can be provided as a cloud-hosted (off-premise) system (e.g., hosted in a server system of a third-party cloud platform provider on behalf of a respective entity).

In the depicted example, the hosted services layer 204 includes cloud platform (CP) instances 210 for each resource management system 210. In some examples, a respective ERP system 208 communicates with a respective CP instance 210 over a network (e.g., the network 110 of FIG. 1) using a protocol (e.g., hypertext transfer protocol secure (HTTPS)). In some examples, each CP instance 210 provides communication connection between a respective ERP system 208, and the DLS layer 206. More particularly, the CP instances 210 communicate with a DLS 212 of the DLS layer 206. In some examples, communication between a CP instance 210, and the DLS layer 206 is conducted using remote procedure calls (RPCs). In some examples, the CP instances 210 “host” DLS nodes for the respective ERP systems 208. For example, the CP instances 210 provide the API for access to DLS.

As described herein, the DLS 212 is provided as a peer-to-peer network including a plurality of nodes 214 that immutably record information in a blockchain 216. Although a single blockchain 216 is schematically depicted, multiple copies of the blockchain 216 are provided and maintained across the DLS 212. For example, each node 214 stores a copy of the blockchain. In some implementations, the blockchain 216 stores information including, without limitation: accounts, credentials, addresses, and the like, of entities, and/or users (e.g., agents of entities) partaking in the cooperative effort; name/value information (e.g., command: setNameValue→name=SUPPLY REQUEST and value=<json>); asset information (e.g., creating assets, transferring assets (command: create, transfer)); and contract information (e.g., creating contracts between entities (command: addPriceContract)).

In accordance with implementations of the present disclosure, prior to beginning tasks in a cooperative effort, the IT landscape (e.g., such as the conceptual architecture 200 of FIG. 2) is empty with respect to the cooperative effort (mission). In some implementations, the IT landscape is configured for the mission. For example, a mission name is established (e.g., Mission 4711). Each ERP system is connected to a node of the DLS. For example, and with reference to FIG. 2, the ERP system 208 of Entity_1 is connected to a node 214 through a respective CP instance 210, the ERP system 208 of Entity _2 is connected to a node 214 through a respective CP instance 210, and the ERP system 208 of Entity_3 is connected to a node 214 through a respective CP instance 210.

In some implementations, a mission-specific, digital currency can be provided (e.g., Mission4711Coins). In some examples, each entity participating in the mission can purchase the digital currency using local currency. In this manner, the entities (e.g., countries) conduct transactions in a common currency (i.e., the mission-specific, digital currency). In some implementations, for each of a plurality of expected transactions, transaction-specific contracts can be defined in the resource sharing platform.

In some implementations, asset costs can be defined in the resource sharing platform. For example, respective costs for assets can be defined and stored in the DLS (e.g., 1 L fuel=1 Mission4711Coins).

Agents of the respective entities download, and install applications that facilitate interactions during the mission. For example, the agents can download and install a mobile application to respective mobile devices (e.g., smartphones, tablets), which facilitate transactions between entities, as described in further detail herein. During the mission, transactions are conducted using the application, and are recorded in respective ERP systems, as well as the DLS. Amounts of the mission-specific, digital currency can be transferred between accounts of the respective entities. In some implementations, upon completion of the mission, the respective ERP systems can request balance information for their account(s) from a node of the DLS. The balance of their mission-specific, digital currency can then be changed to their local currency.

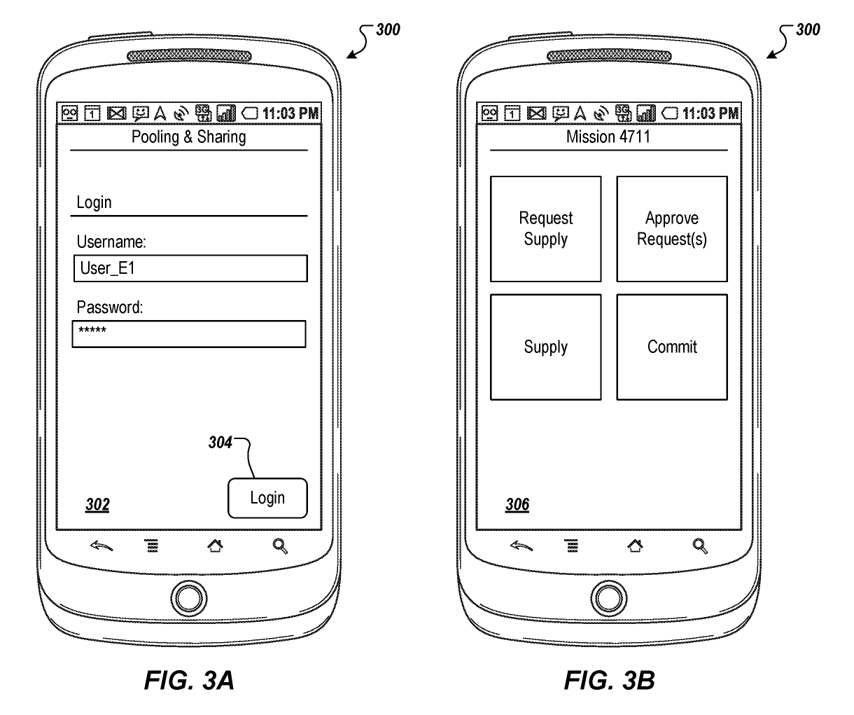

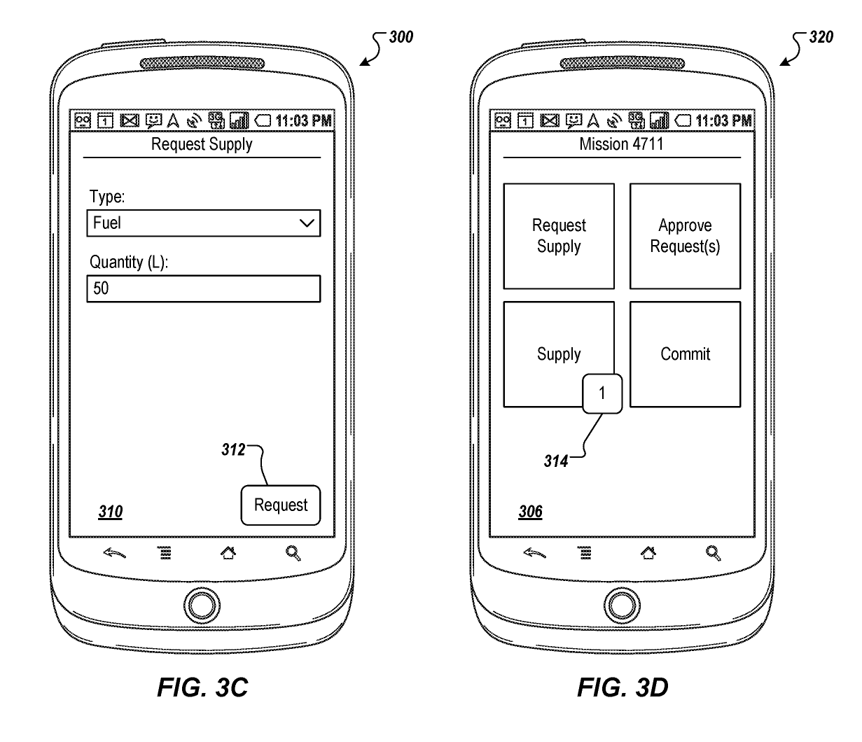

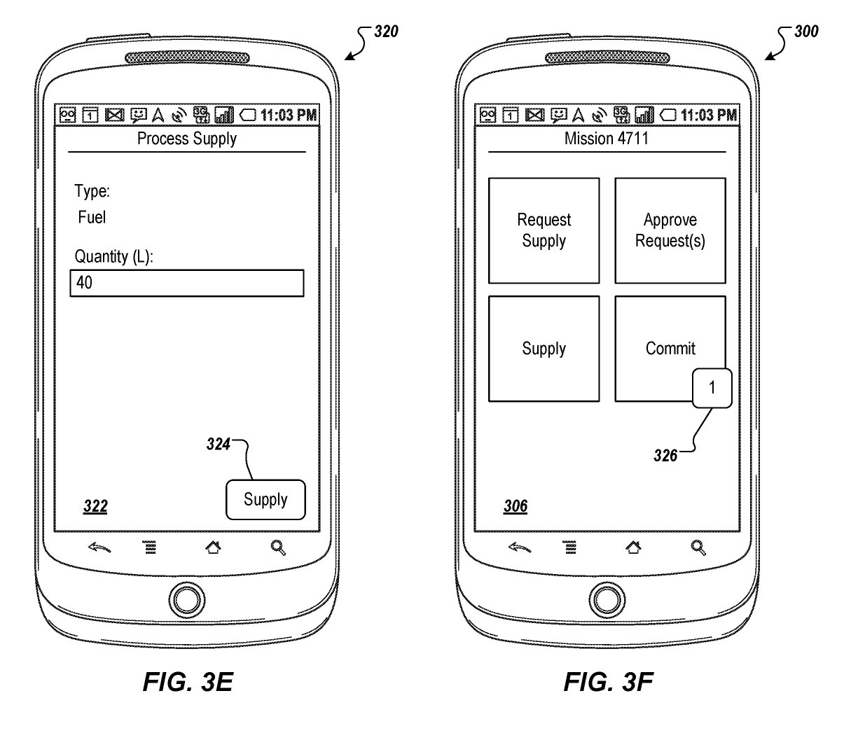

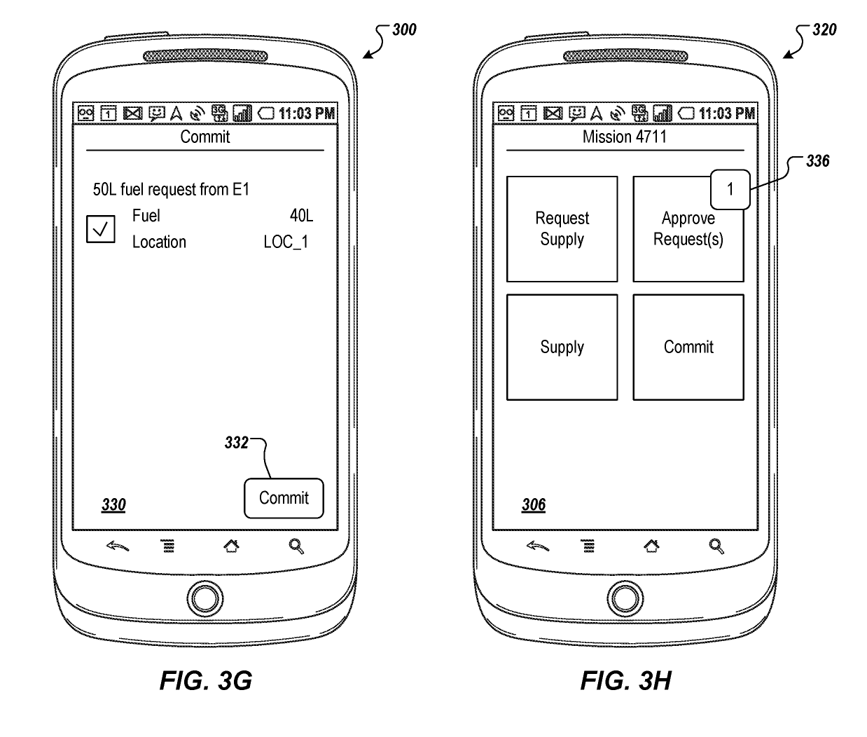

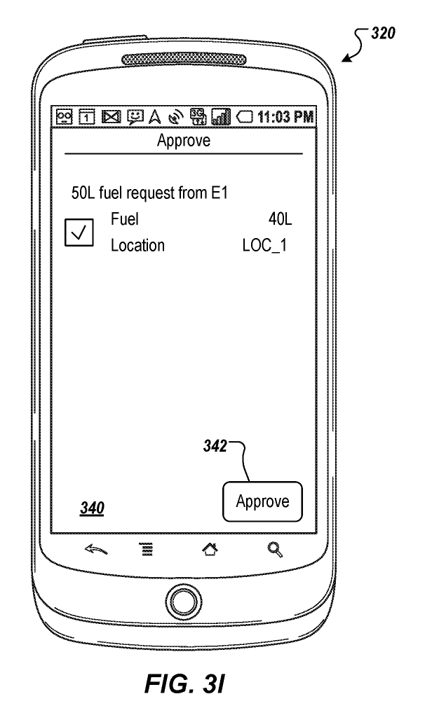

FIGS. 3A-3I depict example screenshots in accordance with implementations of the present disclosure. More particularly, FIGS. 3A-3I depict an example transaction, and user interfaces for executing the transaction.

FIG. 3A depicts an example device 300 used by a first user associated with a first entity, the example device 300 displaying a login screen 302 to enable the first user to log into the resource sharing platform of the present disclosure. For example, the login screen enables the first user to input credentials (e.g., username, password), and submit the credentials by, for example, selecting a login button 304. The credentials are provided to the resource sharing platform, which authenticates the first user based thereon. In some examples, if the first user is authenticated a selection screen (not shown) can be displayed. For example, one or more co-working scenarios (referred to herein as missions) can be concurrently occurring. Consequently, the first user can select a mission for a list of missions displayed in the selection screen.

FIG. 3B depicts the example device 300 displaying a mission landing screen 306. For example, the mission landing screen 306 is displayed in response to the first user selecting “Mission 4711” from the selection screen. In the depicted example, the mission landing screen 306 provides a set of options that can be selected by the first user. Example options include, without limitation, request supply, approve request(s), supply, and commit. In an example, the first user can seek supplies from another entity taking part in the mission. Consequently, the first user can select the request supply option from the mission landing screen 306.

FIG. 3C depicts the example device 300 displaying a request supply screen 310 that enables the first user to input a request for a particular resource, and quantity of the resource. In some examples, the first user can select a type of resource (e.g., form a drop-down menu). In the depicted example, the first user has selected fuel as the type of resource. In some examples, in response to selection of the type of resource, a quantity interface can be adapted. In the depicted example, in response to the type of resource being selected as fuel, the quantity interface is adapted to indicate units of liters (L). For other resources, other units can be provided (e.g., for food, pounds (lbs.) of kilograms (kg); for beverage, liters; for equipment, number). After the first user has input the type and quantity, the first user can submit the request by, for example, selecting a request button 312. In accordance with implementations of the present disclosure, the submitted request is posted to the resource sharing platform for another entity to assist in fulfilling the request.

FIG. 3D depicts an example device 320 used by a second user associated with a second entity, the example device 320 displaying the mission landing screen 306 for Mission 4711. In the depicted example, the supply option includes an annotation 314 indicating a number of pending supply requests from other entities partaking in the mission. In the depicted example, the annotation 314 indicates that a single supply request is pending. For example, the annotation 314 is displayed in response to the first user submitting the supply request described above with reference to FIG. 3C.

FIG. 3E depicts the example device 320 displaying a process supply screen 322. The second user can interact with the process supply screen 322 to at least partially fulfill the supply request. In some examples, a list of supply requests can be displayed in a supply request screen (not shown), and the second user can select a supply request from the list of supply requests. For example, the process supply screen 322 can be displayed in response to the second user selecting the 50 L of fuel request submitted by the first user from the list of supply requests. In the depicted example, the second user inputs a quantity that they are willing/able to fulfill (e.g., 40 L, as opposed to the requested 50 L). The second user can submit the supply quantity by, for example, selecting a supply button 324.

FIG. 3F depicts the example device 300 displaying the mission landing screen 306 for Mission 4711. In the depicted example, the commit option includes an annotation 326 indicating a number of pending supply responses from other entities partaking in the mission. In the depicted example, the annotation 326 indicates that a single supply response is pending. For example, the annotation 326 is displayed in response to the second user submitting the supply response described above with reference to FIG. 3E.

FIG. 3G depicts the example device 300 displaying a commit screen 330 for Mission 4711. In some examples, the commit screen 330 is displayed in response to the first user selecting the commit option from the mission landing screen 306 of FIG. 3F. In some implementations, a list of requests for committal can be provided, and one or more requests can be selected for commitment. In the depicted example, a single request is displayed, and can be selected (e.g., selection of the request can be indicated by a checkmark, as depicted in FIG. 3G). To commit the selected request(s), a commit button 332 can be selected.

FIG. 3H depicts the example device 320 displaying the mission landing screen 306 for Mission 4711. In the depicted example, the approve requests option includes an annotation 336 indicating a number of pending committed requests that are awaiting approval. In the depicted example, the annotation 336 indicates that approval of a single supply response is pending. For example, the annotation 336 is displayed in response to the first user submitting the supply commital described above with reference to FIG. 3G.

FIG. 3I depicts the example device 320 displaying an approve screen 340 for Mission 4711. In some examples, the approve screen 340 is displayed in response to the second user selecting the approve option from the mission landing screen 306 of FIG. 3H. In some implementations, a list of requests for approval can be provided, and one or more requests can be selected for approval. In the depicted example, a single request is displayed, and can be selected (e.g., selection of the request can be indicated by a checkmark, as depicted in FIG. 3I). To commit the selected request(s), an approve button 342 can be selected. The agreed to amount of fuel (e.g., 40 L) can then be transferred from the first entity to the second entity.

The example interactions depicted in FIGS. 3A-3I are immutably recorded in application logs, and the blockchain of the DLS (e.g., the blockchain 216 of the DLS 212). Example recording of the example interactions of FIGS. 3A-3I in an application log can be provided as follows:
User_E1 app:setAccount name:User_E1, account:Account:2
User_E1 app:setMission Mission4711
User_E2 app:setAccount name:User_E2, account:Account:1
User_E2 app:setMission Mission4711
User_E2 app:requestResupply
User_E1 app:checkSupplyRequest
User_E1 app:getSupplyRequest:{“account”:{“account”:“Account:1”},“uic”: “E1”,“location”:“LOCATION”,“demand”:“fuel:50 L”
User_E2 app:getStatus {“account”:{“account”:“Account:1”,“uic”:“E1”,“location”: “LOCATION”,“demand”:“fuel:50 L”
User_E1 app:approve Account:2
User_E2 app:getStatus {“account”:{“account”:“Account:1”,“uic”:“E1”,“location”: “LOCATION”,“demand”:“fuel:50 L”
User_E2 app:supply:{“supplyRequest”:{“account”:{“account”:“Account:1”}, “uic”:“E1”,“location”:“LOCATION”,“demand”:“fuel:50 L”}, “uic”:“E2”,“account”:{“account”:“Account:2”,“suppliedDemand”:“fuel:40 L”},
User_E2 app:commit {“account”:{“account”:“Account:1”},“uic”:“E1”,“location”: “LOCATION”,“demand”:“fuel:50 L”
User_E2 app:getStatus {“account”:{“account”:“Account:1”,“uic”:“E1”,“location”: “LOCATION”,“demand”:“fuel:50 L”
User_E1 app:getStatus {“account”:{“account”:“Account:1”,“uic”:“E1”,“location”: “LOCATION”,“demand”:“fuel:50 L”
User_E2 app:getStatus {“account”:{“account”:“Account:1”,“uic”:“E1”,“location”: “LOCATION”,“demand”:“fuel:50 L”
User_E1 app:getStatus {“account”:{“account”:“Account:1”,“uic”:“E1”,“location”: “LOCATION”,“demand”:“fuel:50 L”

### EXAMPLE APPLICATION LOG

In some examples, the interactions can be recorded in logs of nodes of the DLS (e.g., nodes 214 of the DLS 212 of FIG. 2). Example recording of the example interactions of FIGS. 3A-3I in a node log can be provided as follows:
TRANSACTION:storeData:setNameValue:SUPPLY REQUEST,{“account”: {“account”:“Account:1”,“uic”:“E1”,“location”:“LOCATION”,“demand”:“fuel:50 L”}
TRANSACTION:storeData:setNameValue:status,open
TRANSACTION:storeData:setNameValue:status, approved
TRANSACTION:storeData:setNameValue:SUPPLY RESPONSE, {“supplyRequest”:{“account”:“account”:“Account:1”},“uic”:“E1 % location”: “LOCATION”,“demand”:“fuel:50 L”},“uic”:“E2”,“account”:“account”:“Account:2”},“suppliedDemand”:“fuel:40 L”}
execute price contract:fuel:40 L
TRANSACTIONtransfer asset(s):Account:1→Account:2: 40×Mission4711Coins
TRANSACTION:storeData:setNameValue:status,commit
TRANSACTIONtransfer asset(s):Account:2→Account:1: 40×Mission4711Coins
TRANSACTION:storeData:setNameValue:status,settled
ERPE1 money balance:1040
ERPE2 money balance:960

### EXAMPLE NODE LOG

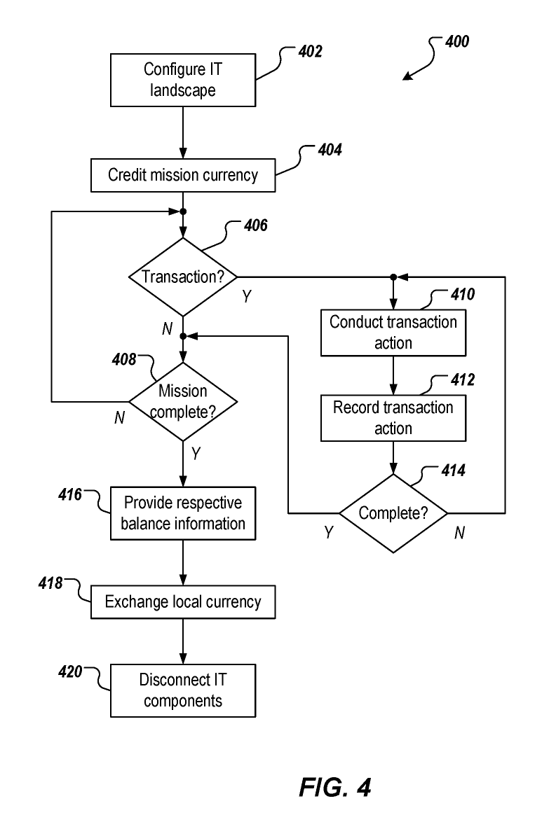

FIG. 4 depicts an example process 400 that can be executed in accordance with implementations of the present disclosure. In some implementations, the example process 400 may be performed using one or more computer-executable programs executed using one or more computing devices.

An IT landscape if configured (402). For example, a cooperative effort, also referred to as mission, is established within a resource sharing platform. In some examples, a DLS-based mission currency (e.g., mission-specific digital currency) is provided, and contracts for resources are defined. For example, the costs of respective resource, in terms of the digital currency, are defined within the resource sharing platform. Further, systems (e.g., ERP systems, CP instances) of respective entities participating in the mission are connected to the DLS, and users (e.g. agents of entities) are established within the resource sharing platform. For example, username, credentials, roles, and the like are established for each user that may request, or provide resources during the mission. In some examples, one or more users download and install an application (e.g., a mobile application) to a computing device (e.g., smartphone, tablet) that enables the users to interact with the resource sharing platform. Mission currency is credited (404). For example, each entity exchanges their local currency for mission currency, and a respective account within the resource sharing platform is credited. The balances of the respective accounts can be recorded in the DLS.

It is determined whether a transaction has been instigated (406). For example, it is determined whether an entity has requested a resource (e.g., as depicted in the examples of FIGS. 3B and 3C, and the respective discussion above). In some examples, one or more users can submit requests to the resource sharing platform (e.g., a request for 50 L of fuel), and the requests are posted to the resource sharing platform, as well as recorded in the DLS. In some examples, users are able to view pending requests, and select a request to supply to initiate a supply transaction.

If a transaction has not been instigated, it is determined whether the mission is complete (408). In some examples, a mission is complete upon expiration of a specified time period since the mission was established (e.g., days, weeks, months, years), upon completion of one or more events, or upon consensus of all entities participating in the mission. In each case, mission completion is recorded in the DLS. If the mission is not complete, the example process 400 loops back.

If a transaction has been instigated, a transaction action is conducted (410). In some examples, a transaction can include actions performed to fulfill a request. Example actions include, but are not limited to, commitment, approval, and supply, as described herein with reference to the examples of FIGS. 3A-3I. The transaction action is recorded (412). For example, the transaction action is recorded in the DLS, as described herein. As another example, the transaction action is recorded in application logs of the respective entities (e.g., an application log of a mobile application a user uses to execute a transaction action). It is determined whether the transaction is complete (414). For example, it can be determined that the supply of a requested resource has been approved (e.g., see the example of FIG. 3I), and/or whether the resources has actually been supplied. If so, the transaction can be considered complete. If the transaction is not complete, the example process 400 loops back to conduct a next action in the transaction. If the transaction is complete, the example process 400 loops back. In some examples, multiple transactions can be concurrently pending, and/or in process.

If the mission is complete, balance information is provide to respective entities (416). For example, for an entity receiving the resource, a corresponding amount of digital currency is debited from their mission account, which can be recorded in both the DLS, and the ERP system of the respective entity. As another example, for an entity providing the resource, a corresponding amount of digital currency is credited to their mission account, which can be recorded in both the DLS, and the ERP system of the respective entity.

If the mission is complete (408) reconciliation, and breakdown of the mission can be performed. For example, for each entity, mission currency is exchanged for local currency (418). In some examples, the amount of mission currency an entity holds is determined form the DLS, and is exchanged for the entity's local currency. IT components are disconnected (420). For example, the mission user accounts of respective users can be deleted, as well as the digital currency accounts of the respective entities (e.g., after reconciliation). Also, the respective systems of the entities (e.g., ERP system, CP instances) can be disconnected from the DLS.

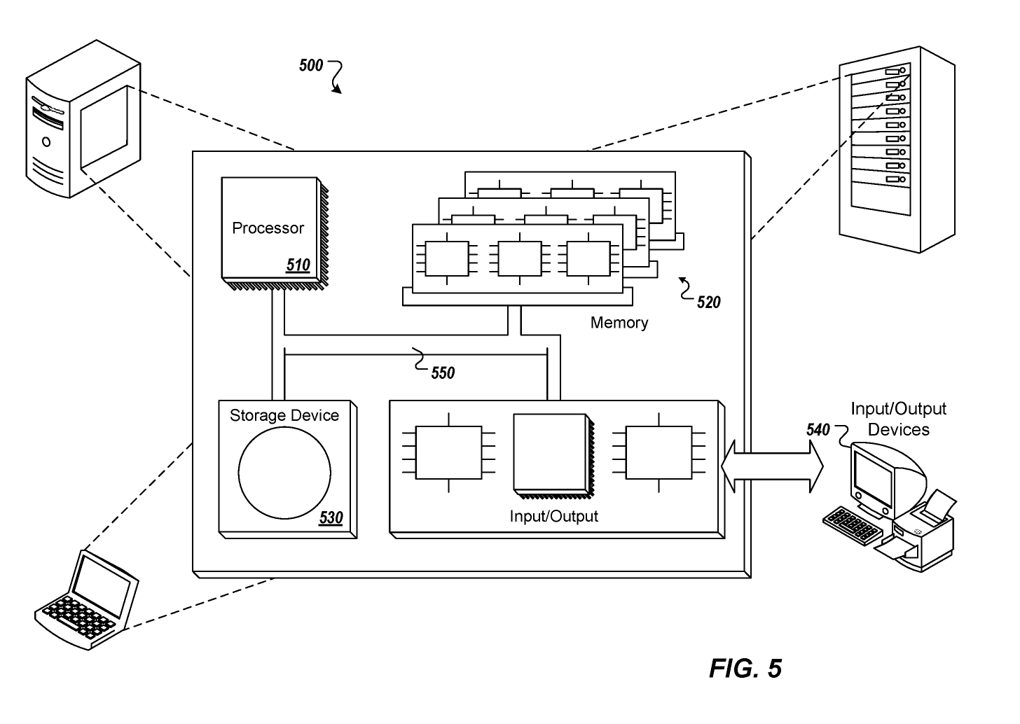

FIG. 5 depicts a schematic diagram of an example computing system 500. The system 500 may be used to perform the operations described with regard to one or more implementations of the present disclosure. For example, the system 500 may be included in any or all of the server components, or other computing device(s), discussed herein. The system 500 may include one or more processors 510, one or more memories 520, one or more storage devices 530, and one or more input/output (I/O) devices 540. The components 510, 520, 530, 540 may be interconnected using a system bus 550.

The processor 510 may be configured to execute instructions within the system 500. The processor 510 may include a single-threaded processor or a multi-threaded processor. The processor 510 may be configured to execute or otherwise process instructions stored in one or both of the memory 520 or the storage device 530. Execution of the instruction(s) may cause graphical information to be displayed or otherwise presented via a user interface on the I/O device 540.

The memory 520 may store information within the system 500. In some implementations, the memory 520 is a computer-readable medium. In some implementations, the memory 520 may include one or more volatile memory units. In some implementations, the memory 520 may include one or more non-volatile memory units.

The storage device 530 may be configured to provide mass storage for the system 500. In some implementations, the storage device 530 is a computer-readable medium. The storage device 530 may include a floppy disk device, a hard disk device, an optical disk device, a tape device, or other type of storage device. The I/O device 540 may provide I/O operations for the system 500. In some implementations, the I/O device 540 may include a keyboard, a pointing device, or other devices for data input. In some implementations, the I/O device 540 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors, the method comprising:
receiving, by the one or more processors, and from a first computing device associated with a first entity participating in a cooperative effort, a request for a transaction to be executed during the cooperative effort, the request requesting one or more resources, each resource being associated with an amount of digital currency;
receiving, by the one or more processors, and from a second computing device associated with a second entity participating in the cooperative effort, a response to the request, the response indicating that the second entity at least partially fulfills the request;
recording, by the one or more processors, the request and the response in a distributed ledger system (DLS), each of the first computing device and the second computing device communicating with respective nodes of the DLS;
logging one or more of the request and the response in respective resource planning systems of the first entity and the second entity, the resource planning systems communicating with respective nodes of the DLS; and
upon ending of the cooperative effort, facilitating reconciliation between the first entity and the second entity based on transaction data recorded in the DLS.

2. The method of claim 1, wherein each of the first computing device and the second computing device execute an application that facilitates communication with the DLS.

3. The method of claim 1, wherein each resource planning system communicates with the DLS through a respective cloud platform instance.

4. The method of claim 1, wherein the transaction data is recorded in a blockchain of the DLS.

5. The method of claim 1, wherein reconciliation at least partially comprises exchanging a balance of digital currency of one of the first entity and the second entity to a local currency.

6. The method of claim 1, wherein the amount of digital currency is defined in a contract on the DLS.

7. The method of claim 1, wherein the digital currency is specific to the cooperative effort.

8. A non-transitory computer-readable storage medium coupled to one or more processors and having instructions stored thereon which, when executed by the one or more processors, cause the one or more processors to perform operations, the operations comprising:
receiving, from a first computing device associated with a first entity participating in a cooperative effort, a request for a transaction to be executed during the cooperative effort, the request requesting one or more resources, each resource being associated with an amount of digital currency;
receiving, from a second computing device associated with a second entity participating in the cooperative effort, a response to the request, the response indicating that the second entity at least partially fulfills the request;
recording the request and the response in a distributed ledger system (DLS), each of the first computing device and the second computing device communicating with respective nodes of the DLS;
logging one or more of the request and the response in respective resource planning systems of the first entity and the second entity, the resource planning systems communicating with respective nodes of the DLS; and
upon ending of the cooperative effort, facilitating reconciliation between the first entity and the second entity based on transaction data recorded in the DLS.

9. The computer-readable storage medium of claim 8, wherein each of the first computing device and the second computing device execute an application that facilitates communication with the DLS.

10. The computer-readable storage medium of claim 8, wherein each resource planning system communicates with the DLS through a respective cloud platform instance.

11. The computer-readable storage medium of claim 8, wherein the transaction data is recorded in a blockchain of the DLS.

12. The computer-readable storage medium of claim 8, wherein reconciliation at least partially comprises exchanging a balance of digital currency of one of the first entity and the second entity to a local currency.

13. The computer-readable storage medium of claim 8, wherein the amount of digital currency is defined in a contract on the DLS.

14. The computer-readable storage medium of claim 8, wherein the digital currency is specific to the cooperative effort.

15. A system, comprising:
a computing device; and
a computer-readable storage device coupled to the computing device and having instructions stored thereon which, when executed by the computing device, cause the computing device to perform operations, the operations comprising:
receiving, from a first computing device associated with a first entity participating in a cooperative effort, a request for a transaction to be executed during the cooperative effort, the request requesting one or more resources, each resource being associated with an amount of digital currency;
receiving, from a second computing device associated with a second entity participating in the cooperative effort, a response to the request, the response indicating that the second entity at least partially fulfills the request;
recording the request and the response in a distributed ledger system (DLS), each of the first computing device and the second computing device communicating with respective nodes of the DLS;
logging one or more of the request and the response in respective resource planning systems of the first entity and the second entity, the resource planning systems communicating with respective nodes of the DLS; and
upon ending of the cooperative effort, facilitating reconciliation between the first entity and the second entity based on transaction data recorded in the DLS.

16. The system of claim 15, wherein each of the first computing device and the second computing device execute an application that facilitates communication with the DLS.

17. The system of claim 15, wherein each resource planning system communicates with the DLS through a respective cloud platform instance.

18. The system of claim 15, wherein the transaction data is recorded in a blockchain of the DLS.

19. The system of claim 15, wherein reconciliation at least partially comprises exchanging a balance of digital currency of one of the first entity and the second entity to a local currency.

20. The system of claim 15, wherein the amount of digital currency is defined in a contract on the DLS.
